(19) United States
(12) Patent Application Publication
(10) Pub. No.: US 2004/0181550 A1
(43) Pub. Date: Sep. 16, 2004

(54) System and method for efficient adaptation of multimedia message content

(76) Inventors: Ville Warsta, Helsinki (FI); Teppo Savinen, Vihti (FI); Petri Timonen, Espoo (FI)

Correspondence Address: Crawford Maunu PLLC, 1270 Northland Drive, Suite 390, St. Paul, MN, 55120, US

(21) Appl. No.: 10/388,209

(22) Filed: Mar. 13, 2003

(51) Int. Cl. G06F 17/00

(52) U.S. Cl. 707/104.1

(57) ABSTRACT

A system and method for providing previously adapted content to requesting network devices. The requesting network device capabilities are compared to the previous requesting network device capabilities, such that if a capability match is found, previously adapted content may be transmitted to the requesting network device, obviating the need for an additional adaptation. In another embodiment, a pre-adaptation method is employed, whereby content adaptations for all known network device capabilities are cached for future use.

### FIELD OF THE INVENTION

This invention relates in general to content adaptation, and more particularly, to efficient content adaptation for multimedia messages subject to repeated or mass distribution.

### BACKGROUND OF THE INVENTION

The launching of the Short Message Service (SMS) has evolved into one of the most successful data services available, and the Multimedia Messaging Service (MMS) is an evolutionary step from SMS that is poised to enjoy equivalent success. Whereas pre-MMS technologies such as SMS and Enhanced Messaging Service (EMS) are limited to the transfer of content such as text, ringing tones, and monochrome bitmap pictures, MMS provides the opportunity to utilize a wide variety of rich content types such as color pictures, audio, music and video clips. MMS is based upon a store and forward model, whereby content is first transferred from one network node to a storage location, with subsequent delivery made to another network node. When the receiving terminal has comparable capabilities and resources with respect to those of the transmitting terminal, content transfer occurs normally without the need for any further consideration of the content's format. If the capabilities and resources between such endpoints are not compatible however, content adaptation becomes an important consideration.

Content adaptation generally refers to the manipulation of content to make the content suitable for specific machines, devices, and applications. Content formatted in accordance with common content formats is a desirable solution, however, market segmentation, equipment capability variation, and the unavoidable introduction of new formats are all true obstacles of interoperability. Generally, a content format refers to a convention of packaging content, where agreement on the format is required in order to build the necessary interoperability between various machines, devices, and applications. Given the limitations of the processing environment within mobile terminals, it is desirable that a reasonably small set of content formats be supported within mobile network offerings. Examples of content where agreement on format is desirable resides in the areas of audio, still images, vector graphics, video and general purpose documents.

Content adaptation may be required, for example, where content generated by one device, i.e., the content source, cannot be delivered to a destination device, i.e., the content sink, in a usable format. In such a case, the content must be made to conform to the constraints of both the delivery network and the content sink, while maintaining the content in a recognizable form. Content requiring adaptation may include an image that exceeds the memory constraints of the destination device, in which case the image may be adapted, e.g., reduced in size, such that the adapted image would fall under the size limit imposed by the destination unit. Another form of content adaptation may be required, for example, when a browser has requested a Uniform Resource Locator (URL) that references Synchronized Multimedia Integration Language (SMIL) content, but the device does not support SMIL content. In this case, for example, the SMIL layout may be converted to an alternative, although not necessarily equivalent scheme, e.g., eXtensible Hypertext Markup Language (XHTML). Still another form of content adaptation may be necessary when a user wishes to receive instant messages sent using the Session Initiation Protocol (SIP) as MMS messages on their mobile terminal. In this case, the instant message would need to be re-packaged using the MMS format. A variety of other situations in which content adaptations may be necessary and/or beneficial can similarly be envisioned.

Currently, rudimentary support for content adaptation for multimedia messages exists, such that content is adapted to support the particular characteristics of a certain mobile terminal. The content adaptation is performed based upon User Agent Profile (UAProf) attributes, which are signaled to the Multimedia Messaging Service Center (MMSC) during a retrieval transaction. Individual content adaptation, however, has a very heavy impact upon throughput and capacity and its use should be minimized so that the amount of hardware a service provider has to invest is kept at a minimum level.

Additionally, multiple requests for the same adapted content may be received, such that for each request, a separate adaptation of content is generated for each retrieval transaction. However, performing duplicative content adaptation for each retrieval transaction results in redundant operations that unnecessarily consume network resources.

Accordingly, there is a need in the communications industry for a system and method that facilitates repeated and/or mass distribution of multimedia messages containing adapted content, such that network efficiency is maximized. The present invention fulfills these and other needs, and offers other advantages over the prior art, by providing a system and method for storing content adaptations for subsequent reuse when content is requested by network elements that are compatible with the adapted content.

### SUMMARY OF THE INVENTION

To overcome limitations in the prior art, and to overcome other limitations that will become apparent upon reading and understanding the present specification, the present invention discloses a system and method for storing and reusing adapted content to maximize the efficiency of distributing the content.

In accordance with one embodiment of the invention, a content adaptation system is provided to adapt content for a plurality of content consumers having varying capabilities. The content adaptation system includes a capabilities service to receive content requests from the plurality of content consumers and to retrieve their respective capabilities, a content adaptation service to provide content adaptations in accordance with the content consumer capabilities, and a database to store the content adaptations. The content adaptations may thus be reused by content consumers having substantially equivalent capabilities.

In accordance with another embodiment of the invention, a server used to facilitate content adaptations on a network is provided. The server is configured to receive a first content request and capabilities associated with the first content request. The server is configured to provide adapted content in response to the first content request, where the adaptation of content is performed in accordance with the received capabilities. The server is further configured to reuse the adapted content for a second content request having substantially equivalent capabilities as compared to the first content request.

In accordance with another embodiment of the invention, a computer-readable medium is provided having instructions stored thereon which are executable by a content adaptation server for facilitating content adaptation by performing steps including receiving a content retrieval request and its associated capability, performing a lookup function to determine availability of previously adapted content that is compatible with the associated capability, and providing the previously adapted content in response to the content retrieval request.

In accordance with another embodiment of the invention, a method for providing adapted content is provided. The method includes receiving capability characteristics of a content requester, and locating previously adapted content relating to capability characteristics of previous content requesters. The previously adapted content is transmitted to the content requester when the capability characteristics of the content requestor substantially match the capability characteristics of the previous content requestors.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIG. 1 illustrates a representative networking environment in which the principles of the present invention may be applied;

FIG. 2 is an exemplary content adaptation functional block diagram;

FIG. 3 is a representative system level implementation of multimedia messaging and related content adaptation in accordance with the present invention;

FIG. 4 illustrates a representative structure of an Multimedia Messaging Service (MMS) Protocol Data Unit (PDU);

FIG. 5 illustrates a HyperText Transfer Protocol (HTTP) post request encapsulation;

FIG. 6 illustrates a functional block diagram of a content adaptation system according to one embodiment of the present invention;

FIG. 7 illustrates an exemplary flow diagram of a method according to one embodiment of the present invention; and

FIG. 8 illustrates a representative computing arrangement suitable for performing content adaptation activity according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a method and system that provides previously adapted content to requesting network devices. The requesting network device capabilities are compared to previous requesting network device capabilities, such that if a capability match is found, previously adapted content may be transmitted to the requesting network device, obviating the need for an additional adaptation. In another embodiment, a pre-adaptation method is employed, whereby content adaptations for all known network device capabilities are cached or otherwise stored for future use.

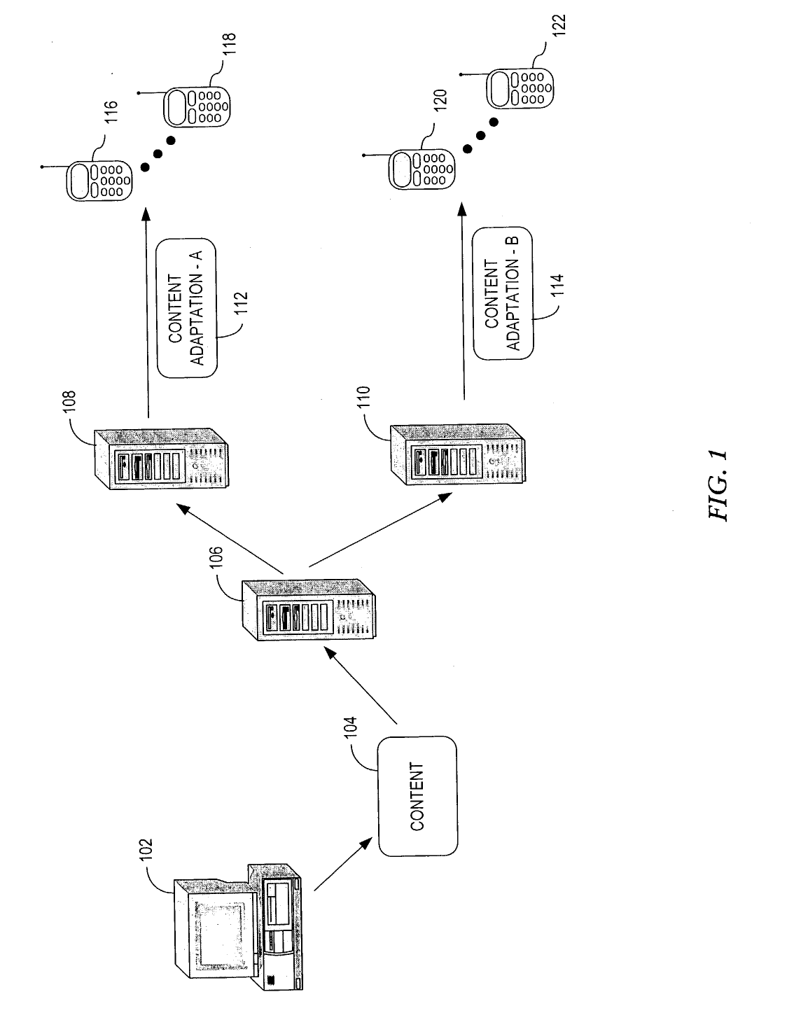

FIG. 1 illustrates a typical networking environment in which content generated by one network element is subsequently proliferated throughout other parts of the network. One aspect of the present invention is to provide a manner for facilitating seamless interaction between the various network elements when content is shared between them. In particular, the complexities involved with the content adaptations required to sustain content compliance with the various network elements are to be masked from the user.

Due to the diversity of mobile terminal capabilities and access methods, instances will arise where content 104, generated by workstation 102, is undeliverable to mobile terminals 116-122, at least in a usable format. In such instances, content 104 may be transmitted to gateway 106 for intermediate storage. Content 104 may include a multitude of content types including, for example, still image graphic data, audio, music and video clips, etc. Although content 104 may be intended for all recipients 116-122, a lack of compatibility with the content, or the method of access to the content, may prevent one or more of mobile terminals 116-122 from appropriately receiving the content.

Content 104 may represent, for example, a graphical image requiring storage capacity that exceeds the capacity of mobile terminals 116-118. In such an instance, content adaptation-A 112 may represent a reduction in quality of the graphical image, thus reducing the storage requirements imposed by the image and allowing mobile terminals 116-118 to receive the image in its lower resolution form, e.g., content adaptation-A 112. Network element 108 may receive content 104 via gateway 106 (or directly), and according to the principles of the present invention cause a content adaptation resulting in a reduction in quality of content 104 to yield content adaptation-A 112. In such an instance, a single content adaptation is required to service the content retrieval sessions performed by mobile terminals 116-118.

Content 104 may represent, on the other hand, a graphical image whose resolution requires a video display that exceeds the capacity of mobile terminals 120-122. In such an instance, content adaptation-B 114 may represent a reduction in resolution of the graphical image, thus reducing the size of the image and allowing mobile terminals 120-122 to receive the image in its lower resolution form, e.g., content adaptation-B 114. Network element 110 may receive content 104 via gateway 106 and according to the principles of the present invention, cause a content adaptation resulting in a reduction in resolution of content 104 to yield content adaptation-B 114. In such an instance, a single content adaptation is required to service the content retrieval sessions performed by mobile terminals 120-122.

Network elements 108 and 110 may be generalized as, for example, Wireless Application Protocol (WAP)/Web proxies that are capable of performing content adaptation as required by mobile terminals 116-122. Not only are network elements 108 and 110 capable of caching or otherwise storing content 104, but they are also able to cache/store (hereinafter “cache”) the various adaptations of content 104, e.g., content adaptation-A 112 and content adaptation-B 114. Having the cached versions of the adapted content available, network elements 108 and 110 merely require the terminal type of mobile terminals 116-122 so that the appropriate link to content adaptations-A 112 or -B 114 may be obtained during the respective retrieval sessions by the mobile terminals.

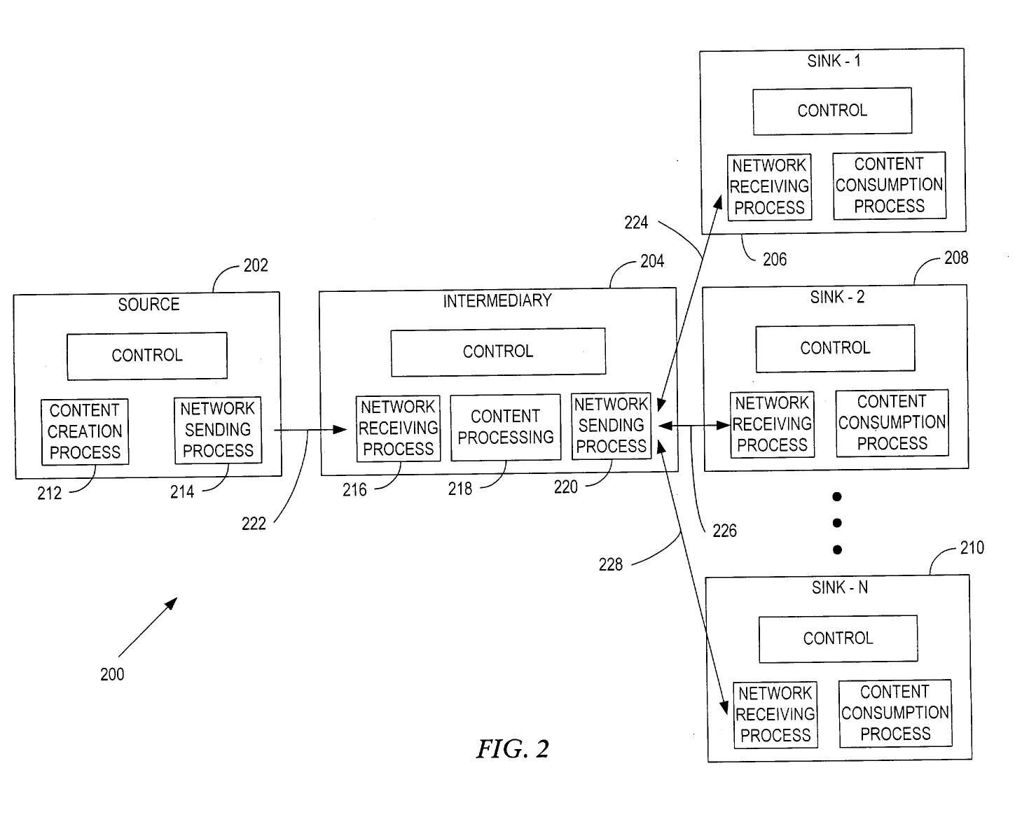

FIG. 2 illustrates an exemplary content adaptation functional block diagram 200 using an intermediary network component. Source node 202 illustrates a functional process that creates content for dissemination throughout the network through the use of content creation process 212. Network sending process 214 forwards the created content to intermediary network node 204 to be received by network receiving process 216. Content processing 218 performs content adaptation, content caching, and retrieval request processing as required, in accordance with one embodiment of the invention. Content processing 218 provides content adaptation for multiple network sink types, e.g., Sink-1 206, Sink-2 208, and Sink-N 210. As content retrieval requests are received from network sink elements 206-210, content processing 218 determines the requestor type and ascertains the existence of a cached version of the content requested that is compatible with requesting network sink elements 206-210. Receiving elements 206-210 and the transport protocols (e.g. 224-228) that deliver the content, support certain capabilities such as maximum size or resolution. The process of adaptation modifies the content to ensure that it conforms to both the sink and transport capabilities, so that the end user is at least able to receive an adapted copy of the content, rather than be denied the content altogether due to size or resolution constraints.

Sink-1 206 through sink-N 210 represents any number of types of network elements from mobile terminals to various internet applications that provide varying degrees of access to the MMS (or other) content. Intermediary 204 represents the network element that performs Multimedia Message Adaptation (MMA) to seamlessly link the content offered by source 202 to the MMS-capable network sink devices 206-210. Intermediary 204, in other words, performs multimedia message adaptation to include message and media format conversion. For example, intermediary 204 may perform WAP MMS to e-mail message format conversion or may perform a Portable Network Graphics (PNG) to Joint Photographic Experts Group (JPEG) conversion and media modification. Media modification may include image scaling or file size reduction to match the MMS characteristics of sink devices 206-210. It should be noted that while the present invention is applicable to any content and network delivery service, various aspects of the invention are described herein in terms of MMS messaging and its supported content for purposes of illustration and to facilitate an understanding of the invention.

One advantage of the present invention is the ability of intermediary 204 to provide mass delivery of adapted content to a wide variety of sink devices, especially to those sink devices comprising mobile terminals. More particularly, mobile terminals each have their own set of capabilities which limits the particular content that may be received and subsequently consumed. Capabilities such as display size, color or gray scale display, processing power, support of content formats, available memory for message storage, and regional differences of the mobile terminals may be of importance when providing adapted content to such mobile terminals. By caching the adapted content for the various capabilities, an efficient mass delivery of content may be realized.

MMS content adaptation scenarios may include MMS to e-mail, e-mail to MMS, and Web publishing, to name only a few. MMS message to e-mail adaptation involves the conversion of the MMS message by intermediary 204 into a multi-body mail message. Intermediary 204 may also convert mobile domain formats such as Wireless Bit Map (WBMP), Wireless Markup Language (WML), and Adaptive Multi-Rate (AMR) to formats that are widely used on the Internet. E-mail to MMS adaptation involves the conversion of a multi-body e-mail message to that of a multi-part MMS message. Additionally, intermediary 204 converts the content format from one that is not supported by the mobile terminal to a format that is supported by the mobile terminal, e.g., PNG to JPEG or Graphics Interchange Format (GIF). Finally, the graphical layout is adapted to the characteristics of the mobile terminal's display by intermediary 204.

Intermediary 204 performs adaptation on units of data referred to as Multimedia Units (MMU), each of which represents a unit of data transmitted over the network that includes one or more multimedia objects, e.g., images, audio, video, text, formatted text, layout information, etc. Encapsulation is one form of adaptation performed by intermediary 204, where encapsulation refers to how one or more multimedia objects are packaged into one data unit ready for transmission. Encapsulation may encompass both low level binary encoding, such as Base64, and application-level protocols, such as HyperText Transfer Protocol (HTTP) or MMS. Encapsulation adaptation primarily encompasses conversion of content from one application-level protocol to another. For example, instant messages using SIP may be converted to the MMS format and vice-versa, or e-mail messages may be converted to/from MMS messages. Encapsulation generally refers to the process of repackaging an MMU without altering any of the content, where a single MMU may be split into a sequence of several MMUs. For example, a long e-mail incident upon an SMS gateway may be split into several SMS messages. Conversely, some technologies may require several MMUs to be combined, where for example, text and images from a Web page are combined into a single MMU.

Intermediary 204 may also perform size adaptation, where the number of bytes in an MMU is constrained either by agreement or by device capabilities. Network constraints encompass not only restrictions on the size of the MMU, but also restrictions on bandwidth and transmission time or latency. Although a bandwidth limit exists, e.g., General Packet Radio Service (GPRS) limits bandwidth to 21.4 kilobits per second (Kbps), the actual bandwidth is often lower and varied with time due to network congestion. For example, video originally streamed at 128 Kbps must be reduced in size, resolution, etc., in order to be transmitted real-time over a 56 Kbps connection. Further, if part of the 56 Kbps connection is suddenly reserved for another purpose, then the video size limit drops even further from 56 Kbps to something less.

Size adaptation may be achieved in several different ways. First, parts of the MMU may be removed in order to comply with the size constraint. Eliminating part of the MMU, however, results in a loss of content such that the sink network element does not receive the same content emitted by the source network element. Certain technologies may mitigate the loss of content to some extent, by designating which part of the MMU is least important.

Second, changing the encapsulation may allow size constraints to be met. For example, if the size limit is due to the transport layer or service protocol, splitting the MMU into several smaller MMUs may be acceptable. Splitting of MMUs, however, may not be acceptable where the limitations of the sink network element causes the size limitation.

Third, format conversion may result in the required size reduction. For example, the JPEG format tends to be optimized to natural scenes, e.g., photographs, and the GIF format tends to be suited to computer graphics. In cases where the current format is not ideally suited to the media, converting it to the optimal format may achieve size reduction.

Fourth, size reduction may be achieved through appearance adaptation, where for example, exactly how the appearance needs to be changed depends upon the content type. Audio content, for example, may require a change in the sampling rate; images may require a change in resolution; and video may require a change in resolution or frame rate. Appearance adaptation is generally motivated by the need to ensure compliance with the capabilities of the receiving device and are thus buried within the encoded content, masked from the underlying network.

Finally, size reduction may be achieved through altering internal media characteristics. In the case of an image, this may mean reducing the quality of the image or the number of colors it contains. In the case of audio, a bit rate alteration may be required. Generally, subtle size reductions are unlikely to be noticeable to the receiving user, especially if one or more techniques are employed to achieve the least amount of degradation in the received content.

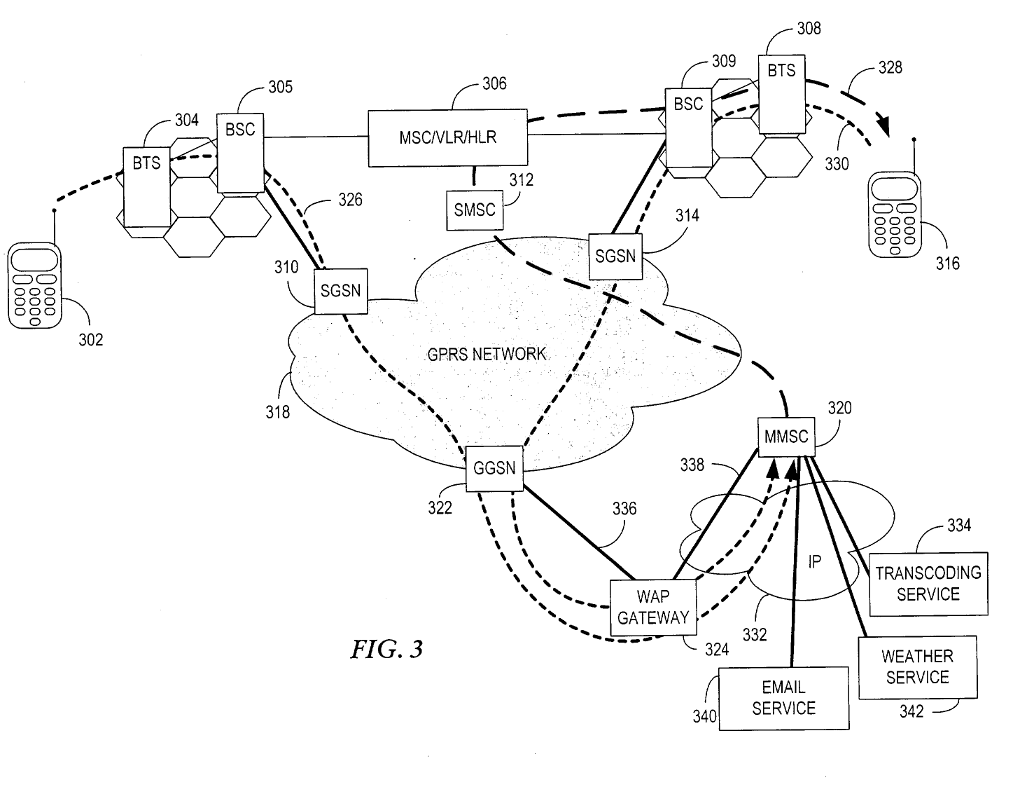

MMS is based on a store and forward model, whereby the content source is forwarded to the content sink via, for example, a GPRS network as illustrated in FIG. 3. FIG. 3 is a diagram illustrating an exemplary embodiment of a system-level implementation of multimedia messaging and related content adaptation. GPRS is a packet-switched service for Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 3 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 3, mobile terminals 302 and 316 communicate with Base Transceiver Station (BTS) 304 and 308, respectively, via an air interface. BTS 304 and 308 are components of the wireless network access infrastructure that terminates the air interface over which subscriber traffic is communicated to and from mobile terminals 302 and 316. Base Station Controller (BSC) 305 and 309 are switching modules that provide, among other things, handoff functions, and power level control in each BTS 304 and 308, respectively. BSC 305 and 309 controls the interface between a Mobile Switching Center (MSC) 306 and BTS 304 and 308, and thus controls one or more BTSs in the call set-up functions, signaling, and in the use of radio channels. BSC 305 and 309 also controls the respective interfaces between Serving GPRS Support Node (SGSN) 310 and BTS 304 and SGSN 314 and BTS 308.

SGSN 310 serves a GPRS mobile terminal by sending or receiving packets via a Base Station Subsystem (BSS), and more particularly via BSC 305 and 309 in the context of GSM systems. SGSN 310 and 314 are responsible for the delivery of data packets to and from mobile terminals 302 and 316, respectively, within the service area, and performs packet routing and transfer, mobility management, logical link management, authentication, charging functions, etc. In the exemplary GPRS embodiment shown in FIG. 3, the location register of SGSN 310 stores location information such as the current cell and Visiting Location Register (VLR) associated with mobile terminal 302, as well as user profiles such as the International Mobile Subscriber Identity Number (IMSI) of all GPRS users registered with SGSN 310. SGSN 314 performs similar functions relating to mobile terminal 316. SGSN 310 and 314 are ultimately coupled to SMSC 312 and/or MMSC 320 in connection with the presently described embodiment. While GSM forms the underlying technology, SGSN 310 and 314 described above are network elements introduced through GPRS technology. Another network element introduced in the GPRS context is the Gateway GPRS Support Node (GGSN) 322, which acts as a gateway between the GPRS network 318 and WAP gateway 324.

MMSC 320 provides messaging capabilities for the delivery of multimedia messages composed of text, photographs, video, and other media types. The messaging capabilities include mobile originated messages sent to other mobile terminals or applications and application originated messages sent to mobile terminals or other applications. MMSC 320 is responsible for storing incoming and outgoing MMS messages, as well as the transfer of messages between different messaging systems, e.g., e-mail service 340. In addition, MMSC 320 may provide an External Application Interface (EAIF) (not shown) that allows application developers and service providers to connect to MMSC 320 to offer value added services to mobile subscribers, such as transcoding service 334 and weather service 342.

With the aforementioned network system described as a representative network environment, a store and forward messaging scenario is now described in which a WAP Push Framework is utilized. Dashed line 326 represents the source multimedia message from mobile terminal 302, which is ultimately posted to MMSC 320. The WAP protocol suite is used as the data transport mechanism because WAP provides data transport services that are optimized for mobile networks. WAP also provides uniform transport services regardless of the underlying network.

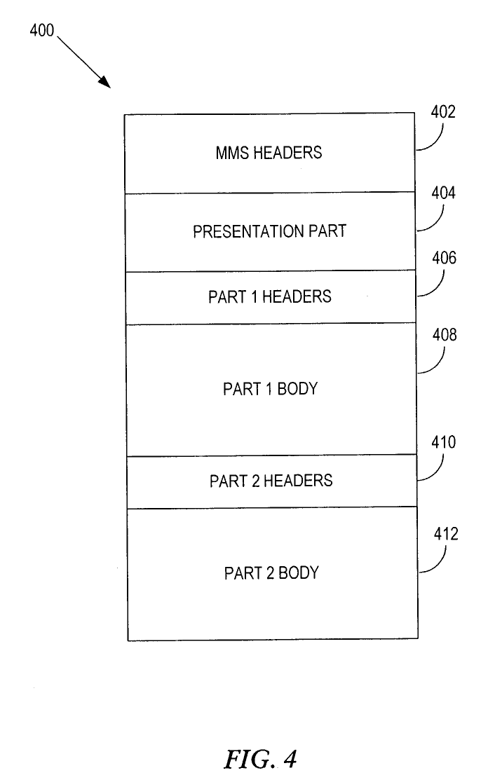

In particular, the Wireless Session Protocol (WSP) layer supplies the basis of the transport mechanism. FIG. 4 illustrates an exemplary MMS Protocol Data Unit (PDU) 400 that may be supplied by mobile terminal 302 during a posting of content to MMSC 320. MMS Headers 402 mainly contain information as to how to transfer the PDU from the originator, e.g. mobile terminal 302, to the destination, e.g. mobile terminal 316. The information may contain such information as source unit identification, sink unit identification, message identification, content type, etc. Presentation part 404 is an optional component of PDU 400 that contains information as to how the content contained within PDU 400 should be rendered onto Input/Output (I/O) of the destination device, e.g. display, speakers, tactile feedback, etc. Part 1 headers 406 and Part 2 headers 410 contain, for example, content indicators that indicate the type of content contained by Part 1 body 408 and Part 2 body 412, respectively. The content type may be any content type supported by MMS such as images, or video, e.g., JPEG or GIF format; and text, e.g. plain or formatted text, to name only a few. Part 1 and Part 2 headers, 406 and 410 respectively, may also contain the location of the content in terms of its file name, e.g. image jpeg or text.plain.

Returning to FIG. 3, MMS messages are sent by mobile terminal 302 for delivery to mobile terminal 316 in, for example, an M-Send.req PDU which contains the Multipurpose Internet Mail Extensions (MIME) encapsulated MMS message content. Either the address of mobile terminal 302 or a token representing the address of mobile terminal 302 is provided within the PDU, along with the content type of the PDU. Dashed line 326 of FIG. 3 indicates the M-Send.req PDU message flow from mobile terminal 302 to MMSC 320. While WSP provides the wireless transport from mobile terminal 302 to WAP gateway 324, HTTP is used to complete the post request message progression to MMSC 320. WAP gateway 324 provides the necessary functionality required to support HTTP encapsulation as required to support multimedia messaging to MMSC 320.

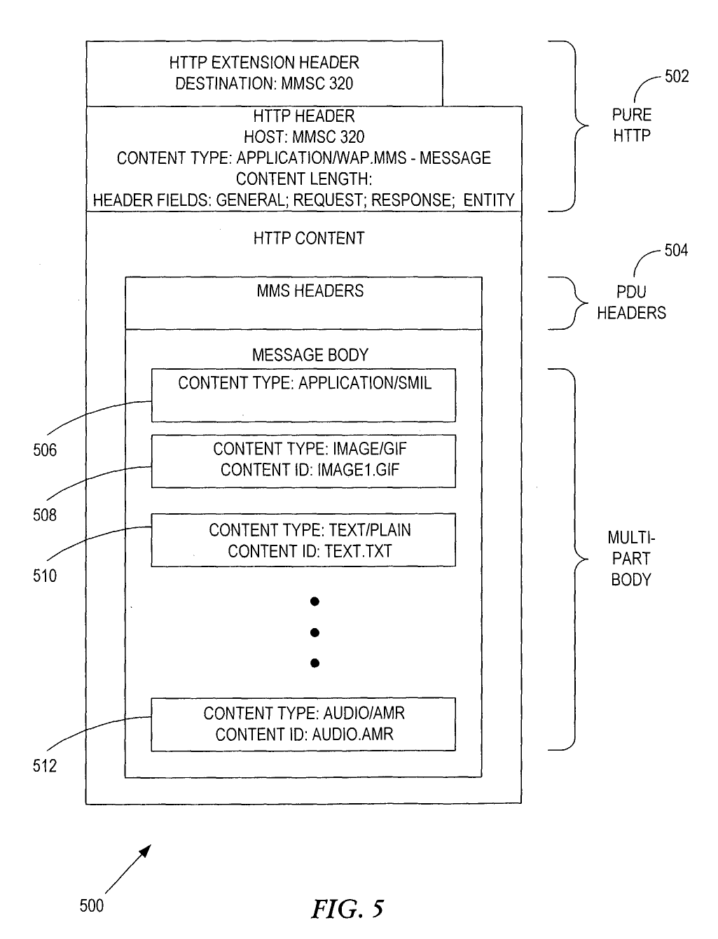

FIG. 5 illustrates HTTP Post Request encapsulation 500 that is required to present the M-Send.req PDU received from mobile terminal 302 in WSP format to MMSC 320 in HTTP format. Pure HTTP 502 contains both the HTTP Extension Header and the HTTP Header, where the HTTP Extension Header is optional. The HTTP Extension Header may provide such information as message ID, message status, charging information (tariff classes), message recipient, message sender, message type (MMS), and MMSC version. The HTTP Header provides mandatory information such as HOST: e.g., MMSC 320; CONTENT TYPE: e.g., MMS message; and CONTENT LENGTH: indicating the length of the multi-body part comprised of, for example, body part components 506-512. In addition, the HTTP Header may contain other header fields denoted as general, request, response and entity. These additional header fields provide functionality control that is invoked by the source of the MMS message and executed by the recipient of the MMS message. Cache control may be invoked by mobile terminal 302, for example, causing MMSC 320 to provide cache operations in response to the received MMS message.

The message body of HTTP encapsulation comprises any number of binary encoded, MIME message parts, where the content type is application/vnd.wap.mms-message. Message part 506 indicates a content type of SMIL that was generated, for example, from a URL accessed by mobile terminal 302 that further referenced SMIL content. Message part 508 indicates that a GIF image exists at location “IMAGE1.GIF”, which is followed by message part 510 containing plain text at location “TEXT.TXT”. Finally, the last message part 512 provides audio content from an Adaptive Multi-Rate (AMR) codec format at location “AUDIO.AMR”.

Once HTTP encapsulated Post Request message 500 has been transmitted to MMSC 320 by WAP gateway 324, an indication as to the content's receipt is provided to mobile terminal 316, which is denoted by dashed line 328. Notification 328 utilizes push semantics defined by the Open Mobile Alliance (OMA), which delivers a receipt notification to the receiving device, e.g., mobile terminal 316, via for example, an SMS bearer and SMSC 312. The MMS PDU that is used to send the notification message within the push message is M-Notification.ind. The M-Notification.ind informs mobile terminal 316 about the contents of received message 326 and its purpose is to allow mobile terminal 316 to fetch multimedia message 326 from MMSC 320. The Notification PDU consists of MMS headers which define characteristics of the multimedia message such as: size of the multimedia message in octets; and the location of the multimedia message, e.g., MMSC 320. Once notification message 328 has been received, a WAP/GET operation may either be automatically or manually initiated in order to receive the content specified by the URI of the notification message. Once the content has been received by mobile terminal 316, notification to the source, e.g., mobile terminal 302, is provided indicating successful receipt of the content.

Mobile terminal 316, prior to performing WAP/HTTP operations with MMSC 320, initiates a capabilities negotiation with MMSC 320. The capabilities negotiation allows the physical characteristics of mobile terminal 316, e.g., screen size, to be known by MMSC 320. The capabilities are communicated according to the UAProf specification and are indicative of the MMS client's hardware, browser user-agent capabilities, network characteristics, and more. Table 1 lists an exemplary set of MMS client characteristics that may be communicated during the capabilities negotiation.

TABLE 1

| | | Sample |
|---|---|---|
| Attribute | Description | Value |
| MMSMaxMessageSize | The maximum size of a | 20,480 |
| | multimedia message in | |
| | bytes | |
| MMSMaxImageResolution | The maximum size of an | 80 × 60 |
| | image in units of pixels | |
| MMSCCPPAccept | List of supported content | image/JPEG |
| | types conveyed as MIME | audio/WAV |
| | types | video/MPEG |
| | | text/PLAIN |
| MMSCCPPAcceptCharSet | List of accepted character | US-ASCII |
| | sets that the MMS client | ISO-8859-1 |
| | supports | |
| MMSCCPPAcceptLanguage | List of accepted languages | English |
| | that the MMS client | French |
| | supports | |
| MMSCCPPAcceptEncoding | List of transfer encodings | base64 |
| | that the MMS client | quoted- |
| | supports | printable |
| MMSVersion | The MMS versions | 2.0 |
| | supported by he MMS | 1.3 |
| | client | |

Once mobile terminal 316 has initially communicated its capabilities with MMSC 320, MMSC 320 then performs content adaptation of the content received from mobile terminal 302, so that the content may be adequately indicated to the user of mobile terminal 316. Alternatively, content may also be received from applications residing within IP network 332, e.g., transcoding service 334, weather service 342, and e-mail service 340, which is subsequently received and adapted by MMSC 320 for consumption by mobile terminal 316.

One advantage offered by the present invention, is the ability of MMSC 320 to not only cache the capabilities of content consumption devices, e.g., mobile terminal 302 and 316, but MMSC 320 may also cache the previously adapted content. In this way, content consumption devices having similar capabilities to other content consumption devices may retrieve content that has already been adapted for use by the other content consumption devices. Thus, the efficiency of the content adaptation process increases with the number of users able to use the cached, adapted content.

In order to present at least some of the advantages offered by the present invention, a temporal sequence is presented that illustrates a typical mass distributed content retrieval scenario. The users of mobile terminals 302 and 316, for example, subscribe to a weather reporting service supplied by weather service 342, whereby weather service 342 pushes weather information to MMSC 320 at periodic intervals. For example, weather service 342 may push weather content to MMSC 320 every morning at 8:00 am for subsequent mass delivery to all subscribers of the weather service.

The user of mobile terminal 302 is operating in a motor vehicle and is notified of the availability of weather content from MMSC 320. Her particular mobile terminal has moderate capabilities such that she is able to retrieve and display MMS messages consisting of plain text, JPEG images having a resolution of 40×30 pixels, and a total MMS message size of 15 Kbytes. After receiving notification of the delivery of the weather content, her mobile terminal initiates a capabilities negotiation with MMSC 320 followed by an MMS retrieval request for the desired weather report.

Having the capabilities of mobile terminal 302, MMSC 320 is able to adapt the weather content provided by weather service 342 in order to be compatible with mobile terminal 302. In particular, weather service 342 not only provides radar graphics of the current conditions, but also offers radar projections of conditions in the future at 6 hour increments. Since retrieval of radar graphics for any future conditions would exceed the memory capability of mobile terminal 302, MMSC 320 limits/adapts the content retrieval to include just the textual weather forecast and the current radar graphic. The adapted content is then cached into a database accessible by MMSC 320 and linked by terminal type. The content retrieval request is fulfilled by MMSC 320 by transmitting the adapted content to mobile terminal 302, whereby the user of mobile terminal 302 is able to view the current radar view and textual weather forecast in order to plan the rest of her drive.

Shortly thereafter, mobile terminal 316 receives notification of the availability of the weather content provided by weather service 342. After completion of the capabilities negotiation, MMSC 320 checks the database for any cached, adapted content that is linked to mobile terminals having capabilities similar to mobile terminal 316. Since mobile terminal 316 has substantially equivalent capabilities to that of mobile terminal 302, a match is found to the cached content. The cached content is then transmitted to mobile terminal 316 immediately, thereby obviating the need for MMSC 320 to re-adapt the content for mobile terminal 316.

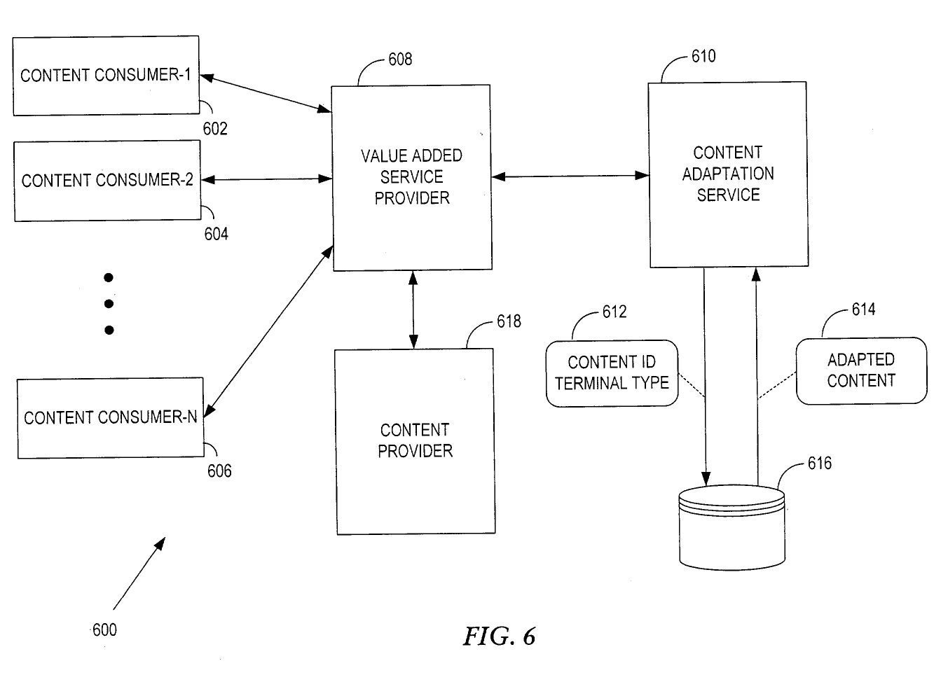

FIG. 6 illustrates a functional block diagram of a content adaptation system according to the principles of the present invention. Content consumers 1 602 through N 606 may represent any network node having the capability to browse for and retrieve content generated by content provider 618. Value Added Service Provider (VASP) 608 receives content requests from content consumers 1 602 through N 606, negotiates their capabilities, and gathers the requested content from content provider 618. VASP 608 also communicates with Content Adaptation Service (CAS) 610 as required in order to adapt the content requested by content consumers 1 602 through N 606 to meet their respective needs. VASP 608 may also determine whether caching of adapted content is permitted, and in the affirmative case, the adapted content is cached within database 616 and indexed according to content ID and terminal type. Signaling of adapted content cache capability may be implemented, for example, using HTTP header information 502 of FIG. 5, in which a toggle bit may be set in the general header portion of header information 502 to indicate whether or not content caching is permitted.

In one embodiment according to the present invention, a pre-adaptation method is performed by VASP 608. In this case, VASP 608 would, for example, correspond to transcoding service 334 of FIG. 3, where transcoding service 334 would have knowledge of all of the current mobile terminal types used on the market at a particular time. Once an MMS retrieve message is received by VASP 608, then the content pertaining to the retrieve message is extracted from content provider 618. The content received would then undergo as many pre-adaptations as required in order to fulfill the needs of content consumers 1 602 through N 606. Each adapted content would be indexed with tag 612 whereby a content ID and a terminal type is used for future recall.

The present invention may be generalized to, for example, WAP/Web Proxies that are configured to perform content adaptation. Taking for example, WAP gateway 324 of FIG. 3, the VASP, content adaptation function, and database function may be incorporated there or in a Web Proxy, thus obviating the need for MMSC 320 to perform content adaptation functions. In general, the present invention is modular, whereby the functions supported by VASP 608, content adaptation service 610, and database 616, for example, may be distributed in one particular implementation, and conversely co-located within a WAP Gateway, a Web Proxy, or MMSC, in another particular implementation.

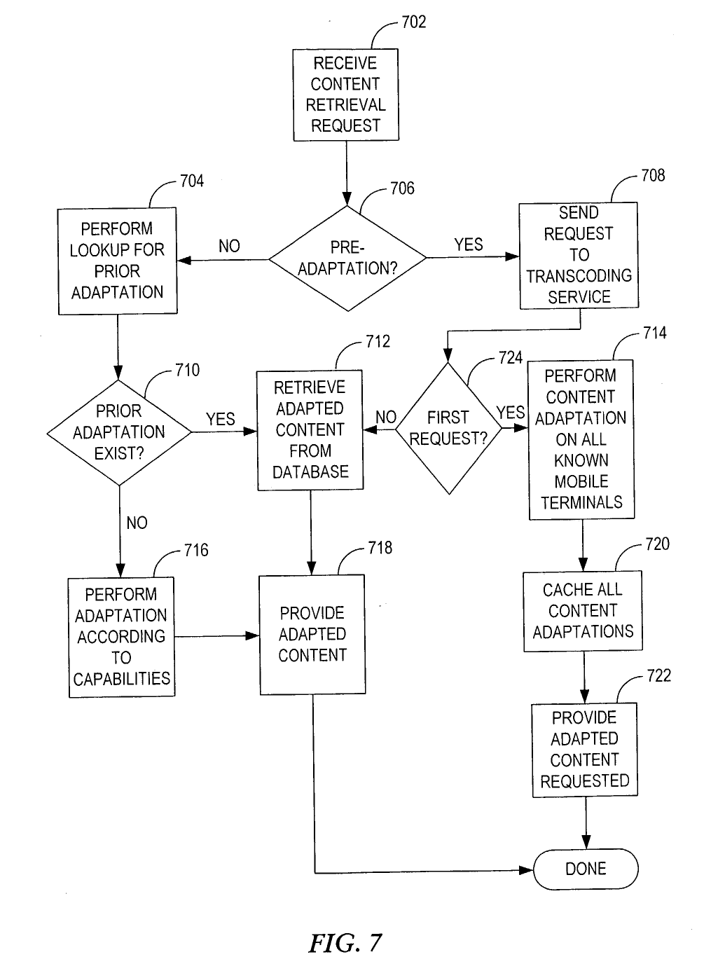

FIG. 7 illustrates an exemplary flow diagram of a method according to the present invention. Content retrieval requests are received in step 702 by, for example, VASP 608 of FIG. 6, WAP gateway 324 or MMSC 320 of FIG. 3. In a pre-adaptation mode of operation, process step 706 takes the Yes path to process step 708. In this case, pre-adaptation is the preferred mode of content adaptation, which requires that content adaptations be provided for all known mobile terminal types and cached for later use. In such an instance, the content retrieval request is passed onto, for example, transcoding service 334 of FIG. 3, whereby the capabilities of all known mobile terminal types is known. For each distinct mobile terminal capability type, a content adaptation is prepared for each mobile terminal capability type in step 714, if not already done as determined by step 724, and subsequently cached into memory in step 720, e.g., database 616 of FIG. 6. The adapted content is also provided to the requesting device for future consumption. If the adaptations have already been performed, then the adapted content is simply retrieved as in step 712 and provided in step 718.

In an alternative embodiment, pre-adaptation is not the preferred mode of content adaptation and the No path is taken from process step 706. In such a case, any content adaptations that have been performed in the past are analyzed in step 704 to determine whether the capabilities of the requesting mobile terminals for the past adaptations match the capabilities of the current requesting mobile terminal. If a match exists, as determined in step 710, the Yes path to step 712 is taken. In step 712, it has been determined that a previous content adaptation does in fact match the capabilities of the current requesting mobile terminal and the adapted content is thus fetched from cache, e.g. database 616, and provided to the current requesting mobile terminal in step 718. If, however, no previous content adaptations exist within database 616, then a new content adaptation is performed in step 716, that matches the capabilities of the current requesting mobile terminal and is subsequently provided to the current requesting mobile terminal in step 718.

The present invention may be used to reduce the amount of overhead generated by providing individual content adaptations, through the use of previously adapted content when previously adapted content is available and usable. The present invention, therefore, allows reuse of adapted content thus increasing the efficiency of the network. In a particular example, 10,000 subscribers may have subscribed to a service that provides the latest sports reports concerning football news. Half of the subscribers each have identical MMS handsets, 20% of the subscribers have an upgraded version of the MMS handset with enhanced capabilities, and the final 30% have a mixture of MMS handsets from various vendors. In such an instance, the present invention allows for the content adaptation of the football news reports into two separate content adaptations, the first adaptation used by the 50% class of subscribers and the second adaptation being used by the 20% class of subscribers, whereby the two content adaptations would serve 70% of the subscriber base. It can be seen, therefore, that the present invention obviates the need for 7,000 independent content adaptations to be performed by first caching the results of two adaptations; and providing the cached results for future use by 70% of the compatible subscribers.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a content adaptation system and method in accordance with the present invention.

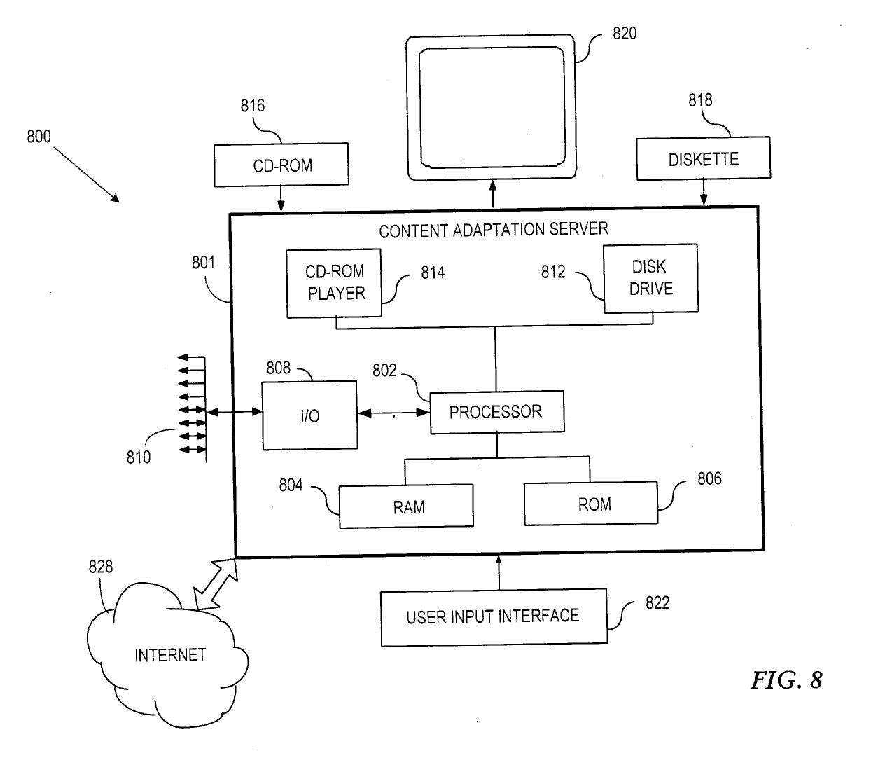

The network servers or other systems for providing content adaptation functions in connection with the present invention may be any type of computing device capable of processing and communicating information. The network servers utilize computing systems to control and manage the content adaptation activity. An example of a representative computing system capable of carrying out operations in accordance with the invention is illustrated in FIG. 8. Hardware, firmware, software or a combination thereof may be used to perform the various content adaptation functions and operations described herein. The computing structure 800 of FIG. 8 is an example computing structure that can be used in connection with such a content adaptation system.

The example computing arrangement 800 suitable for performing the content adaptation activity in accordance with the present invention includes the content adaptation server 801, which includes a central processor (CPU) 802 coupled to random access memory (RAM) 804 and read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. For example, MMS client capabilities such as those exemplified in Table 1 may be received by content adaptation server 801 to enable content adaptation according to the MMS client capabilities. External data storage devices, such as content adaptation databases, may be coupled to I/O circuitry 808 to facilitate lookup functions according to the present invention, to allow reuse of previously adapted content. Alternatively, such databases may be locally stored in the storage/memory of the server 801, or otherwise accessible via a local network or networks having a more extensive reach such as the Internet 828. The processor 802 carries out a variety of functions as is known in the art, as dictated by software and/or firmware instructions.

The content adaptation server 801 may also include one or more data storage devices, including hard and floppy disk drives 812, CD-ROM drives 814, and other hardware capable of reading and/or storing information such as DVD, etc. In one embodiment, software for carrying out the content adaptation operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to the content adaptation server 801 via data signals, such as being downloaded electronically via a network, such as the Internet. The content adaptation server 801 is coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The content adaptation server 801 may be coupled to other computing devices, such as the landline and/or wireless terminals via a network. The server may be part of a larger network configuration as in a global area network (GAN) such as the Internet 828, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A content adaptation system to provide adapted content to a plurality of content consumers having differing capabilities, the content adaptation system comprising:
a capabilities service coupled to receive content requests from the plurality of content consumers and to retrieve their respective capabilities;
a content adaptation service coupled to provide content adaptations in accordance with the plurality of content consumer capabilities; and
a database coupled to store the content adaptations, wherein the content adaptations are reused by content consumers having substantially equivalent capabilities.

2. The content adaptation system according to claim 1, wherein multiple content adaptations are stored based upon the capabilities of a predetermined set of content consumers.

3. The content adaptation system according to claim 2, wherein a first content request initiates the storage of the multiple content adaptations.

4. The content adaptation system according to claim 2, wherein the content adaptations stored in the database are indexed by a terminal type indicative of their corresponding capabilities.

5. The content adaptation system according to claim 4, wherein the content adaptations stored in the database are further indexed by a content identification.

6. The content adaptation system according to claim 5, wherein the content adaptation service provides the index to the database to retrieve content adaptations from the database relating to the index.

7. The content adaptation system according to claim 1, wherein a content adaptation is stored based upon the capabilities of the requesting content consumer.

8. The content adaptation system according to claim 7, wherein a content request from the requesting content customer initiates the storage of the content adaptation.

9. The content adaptation system according to claim 8, wherein the content adaptation stored in the database is indexed by a terminal type indicative of its corresponding capabilities.

10. The content adaptation system according to claim 9, wherein the content adaptation stored in the database is further indexed by a content identification.

11. The content adaptation system according to claim 10, wherein the content adaptation service provides the index to the database to retrieve the content adaptation from the database relating to the index.

12. The content adaptation system according to claim 1, wherein the capabilities service, the content adaptation service and the database are co-located.

13. The content adaptation system according to claim 12, wherein the co-location exists within a Web proxy.

14. The content adaptation system according to claim 12, wherein the co-location exists within a Wireless Application Protocol (WAP) gateway.

15. The content adaptation system according to claim 12, wherein the co-location exists within a Multimedia Messaging Service Center (MMSC).

16. The content adaptation system according to claim 1, wherein the capabilities service, the content adaptation service and the database are distributed throughout the content adaptation system.

17. A server for facilitating content adaptations on a network, comprising:
means for receiving a first content request;
means for receiving capabilities associated with the first content request;
means for providing adapted content in response to the first content request, wherein the adaptation of content is performed in accordance with the received capabilities; and
means for reusing the adapted content for a second content request having capabilities substantially corresponding to the capabilities associated with the first content request.

18. The server according to claim 17, wherein the means for reusing the adapted content comprises a database arranged to store the adapted content.

19. The server according to claim 18, wherein the database is arranged to receive an index indicative of the received capabilities.

20. The server according to claim 19, wherein the database retrieves previously adapted content in response to receiving the index.

21. A computer-readable medium having instructions stored thereon which are executable by a content adaptation server for facilitating content adaptation by performing steps comprising:
receiving a content retrieval request and its associated capability;
performing a lookup function to determine availability of previously adapted content that is compatible with the associated capability; and
providing the previously adapted content in response to the content retrieval request.

22. A method for providing adapted content, comprising:
receiving capability characteristics of a content requester;
locating previously adapted content relating to capability characteristics of previous content requestors; and
transmitting the previously adapted content to the content requester when the capability characteristics of the content requestor substantially match the capability characteristics of the previous content requestors.

23. The method according to claim 22, wherein the previously adapted content is generated based on all known capability characteristics of a predetermined set of content requesters.

24. The method according to claim 23, wherein the previously adapted content is cached.

25. The method according to claim 24, wherein the previously adapted content is retrieved from the cache based upon an index comprising a content identification and a terminal type.

26. The method according to claim 22, wherein the previously adapted content is generated based on the capability characteristics of the content requestor.

27. The method according to claim 26, wherein the previously adapted content is cached.

28. The method according to claim 27, wherein the previously adapted content is retrieved from the cache based upon an index comprising a content identification and a terminal type.
